(19) United States
(12) Patent Application Publication
(10) Pub. No.: US 2006/0104239 A1
(43) Pub. Date: May 18, 2006

(54) Apparatus and method for updating packet data session parameters by PDSN in mobile communications system

(75) Inventor: Won-Ki Hono, Seoul (KR)

Correspondence Address: JONATHAN Y. KANG, ESQ.;LEE, HONG, DEGERMAN, KANG & SCHMADEKA, P.C., 14th Floor, 801 S. Figueros Street, Los Angeles, CA, 90017-6664, US

(73) Assignee: LG-Nortel Co., Ltd

(21) Appl. No.: 11/286,980

(22) Filed: Nov. 23, 2005

(30) Foreign Application Priority Data
Nov. 17, 2004 (KR) 10-2004-0094106
Nov. 23, 2004 (KR) 10-2004-0096192

(51) Int. Cl. H04Q 7/00

(52) U.S. Cl. 370/328

(57) ABSTRACT

Updating packet data session parameters by a PDSN in a mobile communications system. A traffic channel is set between a MS and a BS according to their request, and A8 connection setup between the BS and a PCF and setting of A10 connection or transferring of accounting information are performed. If the PDSN has session parameters to update for the PCF, such are sent to the PCF upon inclusion into an all-registration reply message. The PCF receives this message for updating, and sends updated results to the PDSN using an all-session update Ack message. If the PCF has session parameters to update for the BS after receiving the all-registration reply message from the PDSN, such are sent to the BS upon inclusion into an A9-connect-A8 message. The BS receives this message for updating, and sends updated results to the PCF using an A9-update-A8 message.

### CROSS REFERENCE TO RELATED APPLICATION

Pursuant to 35 U.S.C. § 119(a), this application claims the benefit of earlier filing date and right of priority to Korean Application No. 10-2004-0096192, filed Nov. 23, 2004, the contents of which are hereby incorporated by reference herein in their entirety.

### BACKGROUND OF THE INVENTION

1. Field of the Invention

The present invention relates to updating of packet data session parameters, and particularly, to a method and apparatus for updating packet data session parameters by a Packet Data Serving Node (PDSN) in a mobile communications system.

2. Background of the Related Art

A Packet Data Serving Node (PDSN) in a mobile communications system is a main component of a Data Core Network (DCN) which is a system for providing packet data services to subscribers. The PDSN is a device for applying radio signals to an Internet Protocol (IP) network by an interworking between a Radio Access Network (RAN) corresponding to a radio network access unit and the DCN. In general, a mobile communications system created by the PDSN may include a user terminal (e.g., MS: Mobile Station), a Base Station (BS) for transmitting and receiving data with the MS, a Packet Control Function (PCF) for transmitting and receiving data with each BS, and the PDSN for transmitting and receiving data with the PCF. Such data may be transmitted and received as packet type data between the above identified network elements.

The capacity of the PDSN must be increased in proportion to the increase in the number of wireless internet subscribers and the size of radio data. Especially, the initiation of the so-called “cdma2000 1×EV-DO” service, which is a type of third generation mobile communications system, is actively allowing the development of large capacity PDSN devices. In addition to this, data processing (e.g., control information, accounting information, or the like) between each device and an updating method are recently gaining popularity.

In this regard, a session parameter updating process was added to a third generation mobile communications specification referred to as 3G-IOS v.4.3. All-session update, and all-session update acknowledging messages were added to the specification as an interface message in order to perform this process. The process for updating the session parameters may be classified into two cases according to when updating is performed (i.e., updating time points). Namely, the first case is updating of the session parameters by the PDSN toward directions where the PCF and the BS are located in an active state of the packet data session, and the second case is updating of the session parameters at a time point of setting an A10 connection or re-activating a Packet Data Service Instance (PDSI) in a dormant state. FIG. 1 illustrates the first case, and FIG. 2 illustrates the second case, each of which shows a call flowchart of an interface messaging.

Hereinafter, each case will now be explained in more detail with reference to the drawings.

FIG. 1 is a flowchart illustrating a related art interface messaging for updating session parameters using an all-session update message. The drawing shows a procedure for updating the session parameters by the PDSN toward directions where the PCF and the BS are located in an active state of the packet data session. That is, when the packet data session is active (S1), the PDSN 10 includes new session parameters or updated session parameters in a Normal Vendor/Organization Specific Extension (NVSE) of the all-session update message to thus transfer the message (including the parameters) to the PCF 20 (S2). The PCF 20 having received the message obtains the corresponding session parameters from the NVSE of the all-session update message so as to perform the updating thereof. At this time, the PDSN 10 drives a Tsesupd timer to confirm whether an Ack message (all-session update Ack) with respect to the all-session update message transferred in the step S2 is to be received within a pre-set time.

Then, if it is checked that the session parameters transferred in the step S2 can affect an operation of the BS 30, the PCF 20 uses an A9-update-A8 message to deliver the session parameters to the BS 30 (S3), and drives a Tupd9 timer so as to confirm whether an Ack signal for the A9-update-A8 message is to be received within a pre-set time.

The BS 30 updates the session parameters transferred by being included in the A9-update-A8 message, and then delivers information related to the updated result to the PCF 20 using an A9-update-A8 Ack message (S4). The PCF 20 terminates the Tupd9 timer and confirms whether the A9-update-A8 message having been transferred in step S3 has been successfully transferred. The PCF 20 also transfers the information for the updated result to the PDSN 10 using the all-session update Ack message (S5). The PDSN 10 then terminates the Tsesupd timer having driven and confirms whether the all-session update message having transferred in the step S1 has been successfully transferred.

FIG. 2 is a flowchart illustrating a related art interface messaging for updating session parameters using an all-registration reply message.

Referring to the drawing, the MS 40 sends an origination message to the BS 30 to set a radio traffic channel therebetween (S10). The BS 30 then sends an A9-setup-A8 message to the PCF 20 to request an A8 connection setup (S11). The PCF 20 sends an all-registration request message for requesting an A10 connection setup to the PDSN 10 (S12). If the PDSI is reactivated in a dormant state, the PCF 20 sends the all-registration request message including active start accounting information to the PDSN 10 (S12).

The BS 30 sends the A9-setup-A8 message and drives a T_{A8-setup} timer in the step S11, and the PCF 20 sends the A11-registration request message and drives a Tregreq timer.

Afterwards, the PDSN 10 uses an all-registration reply message to respond to the all-registration request message (S13). At this time, if the PCF 20 and the BS 30 have new or updated session parameters to transfer, the PDSN 10 includes such parameters in the NVSE of the all-registration reply message to send it to the PCF 20. Upon receiving the all-registration reply message, the PCF 20 terminates the operation of the Tregreq timer which is being driven from the step S12.

Thus, upon setting the A8 connection and the A10 connection, the PCF 20 sends an A9-connect-A8 message to the BS 30 in order to inform of the setting completion (S14). At this time, if there are new or updated session parameters to be transferred to the BS 30 among the session parameters having transferred from the PDSN 20, the PCF 20 includes such parameters in the A8-connect-A8 message for sending. Upon receiving the A9-connect-A8 message, the BS 30 terminates the operation of the T_{A8-setup} timer having driven from the step S11.

The A8 and the A10 shown in FIG. 2 are traffic associated communication protocols. The A8 and the A10 are communication protocols defined, respectively, between the BS 30 and the PCF 20 and between the PCF 20 and the PDSN 10.

As explained above, in the related art technology shown in FIG. 1, the A9-update-A8 Ack and the all-session update Ack message can be used to inform the PDSN of the updated result of the session parameters. However, in the related art technology shown in FIG. 2, because there is no process to send and/or receive the Ack messages (i.e., response interface messages) respectively corresponding to the A9-connect-A8 message and the all-registration reply message, the processed result of the session parameter updating can not be informed to the PDSN 10. Accordingly, it can not be confirmed whether the session parameters have been successfully updated, and thus there may occur a problem in reliability of the session parameter updating.

### BRIEF DESCRIPTION OF THE INVENTION

Therefore, an object of the present invention is to provide a method and apparatus for transferring a performed result of an updating to a PDSN as similar as updating of session parameters using an all-session update message even if the PDSN performs updating of the session parameters using an all-registration reply message in response to an A10 connection request.

To achieve these and other advantages and in accordance with the purpose of the present invention, as embodied and broadly described herein, there is provided a method for updating packet data session parameters by a PDSN in a mobile communications system in which a traffic channel is set between a Mobile Station (MS) and a Base Station (BS) according to the request by the MS or the BS, and an A8 connection setup between the BS and a Packet Control Function (PCF) and an A10 connection setup or an accounting information transfer are performed, the method comprising: (a) sending session parameters by being loaded in an all-registration reply message from the PDSN to a PCF; (b) sending an all-registration reply message including the session parameters and driving a first timer by the PDSN; (c) receiving the all-registration reply message, by the PCF, to thus update the session parameters included therein; (i) sending information related to the updated result of the session parameters, by the PCF, to the PDSN using an all-session update Ack message; and (j) receiving the information related to the updated result of the session parameters at the PDSN, and terminating an operation of the first timer.

Preferably, the method for updating session parameters in a mobile communications system may further comprise when the PCF has session parameters to update to the BS in the step (c); (d) sending session parameters by being loaded in an A9-connect-A8 message from the PCF to the BS; (e) sending the A9-connect-A8 message including the session parameters and driving a second timer by the PCF; (f) receiving the A9-connect-A8 message, by the BS, to thus update the session parameters included therein; (g) sending information related to the updated result of the session parameters using an A9-update-A8 message from the BS to the PCF; and (h) receiving the information related to the updated result of the session parameters, by the PCF, and terminating an operation of the second timer.

According to another embodiment of the present invention, an apparatus for updating packet data session parameters by a PDSN in a mobile communications system can comprise: a PDSN for including session parameters in an all-registration reply message to send the message to a PCF when the session parameters to be updated exist, and receiving an all-session update Ack message including information related to the updated result of the session parameters from the PCF; the PCF for receiving the all-registration reply message from the PDSN to update the session parameters included in the message, sending certain session parameters related to the BS by including in an A9-connect-A8 message to the BS when the corresponding session parameters are included in the session parameters, and receiving an A9-update-A8 Ack message including information related to the updated result of the session parameters from the BS; and the BS for receiving an A9-connect-A8 message from the PCF to update the session parameters included in the message, and sending the updated result of the session parameters to the PCF using the A9-update-A8 Ack message.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a flowchart illustrating a related art interface messaging for updating session parameters using an all-session update message;

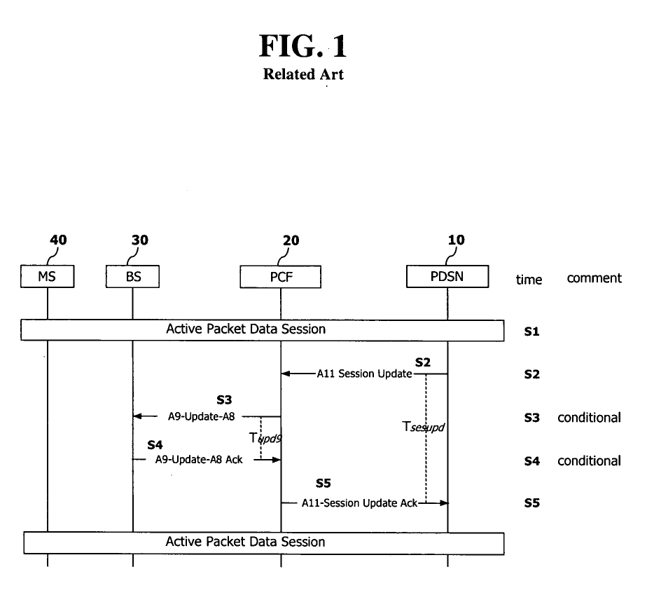

FIG. 2 is a flowchart illustrating a related art interface messaging for updating session parameters using an all-registration reply message; and

FIG. 3 is a flowchart illustrating an interface messaging for updating session parameters using an all-registration reply message in accordance with an exemplary embodiment of the present invention.

### DETAILED DESCRIPTION OF THE INVENTION

Reference will now be made in detail to the preferred embodiments of the present invention, examples of which are illustrated in the accompanying drawings.

A basic concept of the present invention is to add to a call flow, an A9-update-A8 Ack message and an all-session update Ack message, which are response interface messages respectively corresponding to an A9-connect-A8 message and an all-registration reply message, thereby allowing a PDSN 10 to be informed of an updated result of session parameters.

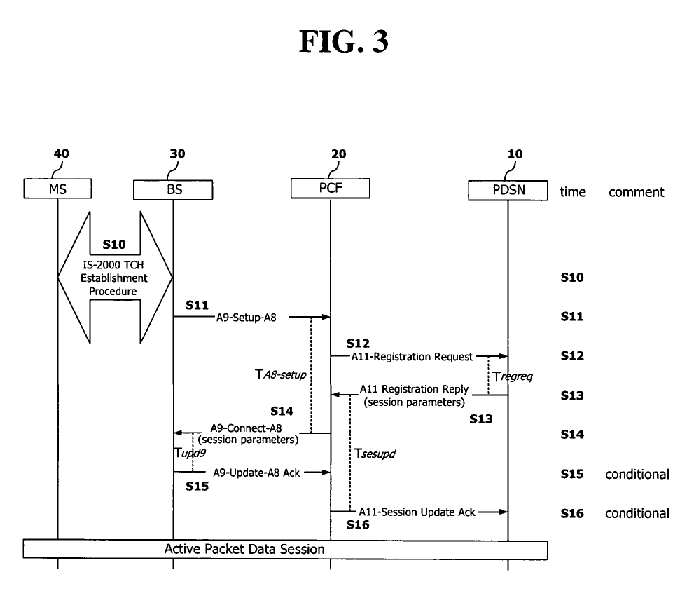

FIG. 3 is a flowchart illustrating an interface messaging for updating session parameters using an all-registration reply message in accordance with an exemplary embodiment of the present invention.

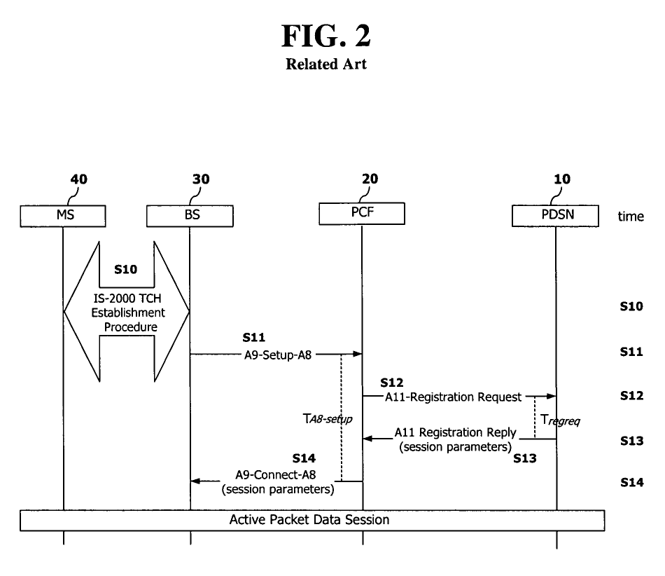

As illustrated in FIG. 3, in the present invention, an A9-update-A8 Ack message and an all-session update Ack message may be added to the call flow of the interface messaging according to the related art illustrated in FIG. 2. Here, it should be noted that the same reference numerals in FIGS. 2 and 3 have the same functions and operations. An exemplary call flow procedure of an interface messaging according to the present invention will be described, but certain features that overlap with the related art will not be explained in detail again, to prevent the features of the present invention from being obscured.

Referring to FIG. 3, when the MS 40 sends an origination message to the BS 30 to set a radio traffic channel therebetween (S10), the BS 30 may send an A9-setup-A8 message to the PCF 20 to request an A8 connection setup (S11). The BS 30 may send the A9-setup-A8 message and may also drives a T_{A8-setup} timer in the step S11.

Afterwards, the PCF 20 may send to the PDSN 10 an all-registration request message for requesting an A10 connection setup or requesting an accounting information transfer. Upon re-activating a packet data service instance (PDSI) in a dormant state, the PCF 20 may send an all-registration request message that may include active start accounting information to the PDSN 10 (S12). The PCF 20 may send the all-registration request message and may also drive a Tregreq timer in the step S12.

Then, the PDSN 10 may reply to the request for the A10 connection setup using an all-registration reply message (S13). At this time, if other new or updated session parameters to be transferred to the PCF 20 and the BS 30 exist, the PDSN 10 may include such session parameters in a Normal Vendor/Organization Specific Extension (NVSE) of the all-registration reply message to send the message to the PCF 20 (S13), and may drive a Tsesupd timer. The PCF 20 may then receive the all-registration reply message to update the session parameters included in the NVSE of the message. The PCF 20 may also terminate an operation of the Tregreq timer being driven from the step S12.

Upon completing the A8 connection setup and the A10 connection setup or the accounting information transfer through such steps (S11 and S12), the PCF 20 may send an A9-connect-A8 message to the BS 30 in order to inform the completion of the connection setup (S14). At this time, if other new or updates session parameters to be transferred to the BS 30 exist, the PCF 20 may include the session parameters in the A9-connect-A8 message to send the message to the BS 30, and may drive a Tupd9 timer. The BS 30 may receive the A9-connect-A8 message from the PCF 20 to update the session parameters included in the message, and may also terminate the operation of the T_{A8-setup} timer being driven from the step S11. The BS 30 may also send an A9-update-A8 Ack message including information of the updated result of the session parameters performed in the step S14 to the PCF 20 (S15). The PCF 20 may terminate the operation of the Tupd9 timer being driven from the step S14.

Thereafter, when the PCF 20 has received and updated the session parameters in the step S13, the PCF 20 may transfer information related to the updated result to the PDSN 10 using an all-session update Ack message (S16). The PDSN 10 may terminate the operation of the Tsesupd timer.

Here, the Tupd9 timer and the Tsesupd timer may be used to confirm whether the corresponding Ack messages of the interface messages have been received within a pre-set time from a time point of sending each interface message including the session parameters, and to confirm whether the updating of the session parameters has been successfully performed.

If session parameters corresponding to the BS 30 are not included in such session parameters included in the all-registration reply message which the PDS 10 transfers to the PCF 20, the A9-connect-A8 message which does not include any session parameters may be transferred in the step S14. Accordingly, the Ack message of the step S15 may not be generated, and the PCF 20 may immediately perform the step S16.

The updating process of the session parameters illustrated in FIG. 3 may be performed by the A10 connection setup of the PDSI, and also may be adapted when a new or updated Radio Network Packet Data Inactivity Timer (RN-PDIT) or an always-on indicator with respect to the corresponding PDSI is desirably to be transferred to the PCF 20 or the BS 30 upon re-activating the PDSI in a dormant state. Here, the RN-PDIT or the always-on indicator may correspond to one parameter that constitutes the session parameters.

As mentioned above, the updating of the packet data session parameters by the PDSN in the (mobile) communications system has been explained according to the call flow. Exemplary components of the system will now be explained.

A (mobile) communications system for performing the updating of the packet data session parameters by the PDSN according to the present invention may comprise a PDSN 10, a PCF 20, a BS 30 and MS 40.

The PDSN 10 may include session parameters in an all-registration reply message to thus send the message to the PCF 20 when the session parameters to be updated to the PCF 20 and the BS 30 exist. The PDSN 10 may also have a first timer for confirming whether an all-session update Ack including the updated result of the session parameters is received from the PCF 20 within a pre-set time.

The PCF 20 may receive the all-registration reply message from the PDSN 10 to update the session parameters included in the message. When the session parameters corresponding to the BS are included in the all-registration reply message, the PCF 20 may include the corresponding session parameters in an A9-connect-A8 message to thus send the message the BS 30. The PCF 20 may also have a second timer for confirming whether an A9-update-A8 Ack message including information related to the updated result of the session parameters is received from the BS 30 within a pre-set time.

In particular, when the all-registration reply message which does not include the session parameters corresponding to the BS 30 has been received, the PCF 20 may send information related to the updated result of the session parameters to the PDSN 10 using an all-session update Ack.

The BS 30 may receive the A9-connect-A8 message from the PCF 20 to update the session parameters included in the message, and may send information related to the updated result of the session parameters to the PCF 20 using the A9-update-A8 Ack message.

As described above, in the related art, when the session parameters have been updated, the updated result could not be transferred from the BS 30 to the PCF 20, or from the PCF 20 to the PDSN 10. However, in the present invention, the update result of the session parameters may be transferred from the BS 30 to the PDSN 10, and accordingly the following steps may be adjusted according to the resultant information, which results in an improved reliability of the updating of the session parameters.

In addition, the related art system can be utilized (without requiring major modifications) by adding only the A9-update-A8 Ack message and the all-session update Ack message to the call flow, while maintaining the existing processes from the transferring of A9-setup-A8 message for setting the A8 connection and the A10 connection to the transferring of the A9-connect-A8 message, and thus the cost required for creating the system can be effectively minimized.

Furthermore, even while the packet data session is not active, the updating of session parameters having great reliability can be performed at the call flow for setting the A8 connection and the A10 connection, thereby increasing performance efficiency for the updating of the session parameters.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A method for updating packet data session parameters by a Packet Data Serving Node (PDSN) in a mobile communications system in which a traffic channel is set between a Mobile Station (MS) and a Base Station (BS) according to a request by the MS or the BS, and an A8 connection setup between the BS and a Packet Control Function (PCF) and setting of an A10 connection or transferring of accounting information are performed, the method comprising:
(a) including, by the PDSN, session parameters into an all-registration reply message to be sent to the PCF;
(b) sending, by the PDSN, the all-registration reply message that includes the session parameters to the PCF, and driving a first timer by the PDSN;
(c) receiving, by the PCF, the all-registration reply message to thus update the session parameters included therein;
(d) sending, by the PCF, information related to an updated result of the session parameters to the PDSN by using an all-session update Ack message; and
(e) receiving, by the PDSN, the information related to the updated result of the session parameters, and terminating an operation of the first timer.

2. The method of claim 1, wherein if the PCF has session parameters to update to the BS, the step (c) further comprises:
(c-1) including, by the PCF, session parameters into an A9-connect-A8 message to be sent to the BS;
(c-2) sending, by the PCF, the A9-connect-A8 message that includes the session parameters to the BS, and driving a second timer by the PCF;
(c-3) receiving, by the BS, the A9-connect-A8 message to thus update the session parameters included therein;
(c-4) sending, by the BS, information related to an updated result of the session parameters to the PCF by using an A9-update-A8 message; and
(c-5) receiving, by the PCF, the information related to the updated result of the session parameters, and terminating an operation of the second timer.

3. The method of claim 1, wherein the session parameters selectively include a Radio Network Packet Data Inactivity Timer (RN-PDIT).

4. The method of claim 1, wherein the session parameters selectively include an always-on indicator.

5. A method for updating packet data session parameters by a Packet Data Serving Node (PDSN) in a mobile communications system in which a traffic channel is set between a Mobile Station (MS) and a Base Station (BS) according to the request by the MS or the BS, and an A8 connection setup between the BS and a Packet Control Function (PCF) and setting of an A10 connection or transferring of accounting information are performed, the method comprising:
including, by the PDSN, session parameters into a first interface message that is sent to the PCF, if the PDSN has session parameters to be updated for the PCF; and
receiving, by the PCF, the first interface message to perform updating of session parameters, and then sending an updated result to the PDSN using a second interface message for responding thereto.

6. The method of claim 5, wherein the first interface message is an all-registration reply message.

7. The method of claim 5, wherein the second interface message is an all-session update Ack message.

8. The method of claim 5, wherein the PDSN includes a timer for confirming whether the second interface message is received within a pre-set time after sending the first interface message.

9. A method for updating packet data session parameters by a Packet Data Serving Node (PDSN) in a mobile communications system in which a traffic channel is set between a Mobile Station (MS) and a Base Station (BS) according to the request by the MS or the BS, and an A8 connection setup between the BS and a Packet Control Function (PCF) and setting of an A10 connection or transferring of accounting information are performed, the method comprising:
sending, by the PCF to the BS, session parameters upon inclusion into a third interface message, if the PCF has session parameters to update to the BS after receiving an all-registration reply message from the PDSN; and
receiving, by the BS, the third interface message and performing updating of session parameters, and sending an updated result to the PCF using a fourth interface message for responding thereto.

10. The method of claim 9, wherein the third interface message is an A9-connect-A8 message.

11. The method of claim 9, wherein the fourth interface message is an A9-update-A8 Ack message.

12. The method of claim 9, wherein the PCF includes a timer for confirming whether the fourth interface message is received within a preset time after sending the third interface message.

13. An apparatus for updating packet data session parameters by a packet Data Serving Node (PDSN) in a mobile communications system, the apparatus comprising:
a PDSN for sending, to a Packet Control Function (PCF), session parameters upon inclusion into an all-registration reply message, if the session parameters to be updated exist, and receiving, from the PCF, an all-session update Ack message including information related to the updated result of the session parameters;
the PCF for receiving from the PDSN, the all-registration reply message to update the session parameters included in the message, sending to a base station (BS), certain session parameters related to the BS upon inclusion into an A9-connect-A8 message when the corresponding session parameters related to the BS are included in the session parameters, and receiving from the BS, an A9-update-A8 Ack message including information related to an updated result of the session parameters; and
the BS for receiving from the PCF, an A9-connect-A8 message to update the session parameters included in the message, and sending to the PCF, an updated result of the session parameters using the A9-update-A8 Ack message.

14. The apparatus of claim 13, wherein the PDSN includes a timer for confirming whether the all-session update Ack message is received within a pre-set time after sending the all-registration reply message.

15. The apparatus of claim 13, wherein the PCF includes a timer for confirming whether the A9-update-A8 Ack message is received within a pre-set time after sending the A9-connect-A8 message.

16. The apparatus of claim 13, wherein the PCF sends an all-session update Ack message to the PDSN when the PCF has received the all-registration reply message which does not include session parameters corresponding to the BS.

17. A mobile communications network comprising:
a Packet Data Serving Node (PDSN) to perform updating of packet data session parameters by,
including session parameters into a first interface message,
sending the first interface message and starting a first timer, and
receiving information related to session parameters updating, and stopping the first timer.

18. The network of claim 17, further comprising:
a Packet Control Function (PCF) in communication with the PDSN to perform the steps of,
receiving the first interface message and performing updating using the session parameters included therein, and sending the information related to session parameters updating by using a second interface message, and
including session parameters into a third interface message to be sent, sending the third interface message that includes the session parameters, and starting a second timer, and receiving information related to session parameters updating, and stopping the second timer.

19. The network of claim 18, further comprising:
a base station (BS) in communication with the PCF to perform the steps of,
receiving the third interface message and performing updating using the session parameters included therein, and
sending the information related to session parameters updating by using a fourth interface message.

20. The network of claim 19, wherein the first interface message is an all-registration reply message, and the second interface message is an all-session update Ack message, the third interface message is an A9-connect-A8 message, and the fourth interface message is an A9-update-A8 Ack message.
